(19) United States
(12) Patent Application Publication
(10) Pub. No.: US 2005/0164047 A1
(43) Pub. Date: Jul. 28, 2005

(54) Voltage dosimeter-system and method for supplying variable voltage to an electric circuit

(76) Inventor: Adolph Mondry, Plymouth, MI (US)

Correspondence Address: ADOLPH MONDRY, 753 VIRGINIA, PLYMOUTH, MI, 48170, US

(21) Appl. No.: 10/739,207

(22) Filed: Dec. 19, 2003

(51) Int. Cl. H01M 8/04; G05F 1/10

(52) U.S. Cl. 429/13; 323/234; 429/23

(57) ABSTRACT

The Voltage Dosimeter is a method and apparatus that automatically controls voltage producing sources to deliver varying voltage to reduce the need for constant voltage production and it provides switching ability between devices by maintaining the negative electrode voltage of voltage producing sources in a predetermined range. In the preferred embodiment a maximal reactive gas flow rate produces the first positive electrode voltage dosage of a fuel cell, then positive electrode voltage doses repeatedly sequence at predetermined intervals from smallest to largest until the current negative electrode voltage is in the desired range. Then the reactive gas flow rate and positive electrode voltage dosage are selected. The method continues with the delivery of the selected reactive gas flow rate and positive electrode voltage dose by the voltage producing source so as to maintain the negative electrode voltage in the desired range.

### CROSS REFERENCES TO RELATED APPLICATIONS

Adolph Mondry—System and method for automatically maintaining a blood oxygenation level. U.S. Pat. No. 5,682,877, Nov. 4, 1997—herein referred to as 877. The flow sheets of that device are similar to those of the Voltage Dosimeter.

Meland Kantak—Internal fuel staging for improved fuel cell performance. P.N. application 20020081479—herein referred to as 479. A similar device is used in the Voltage Dosimeter.

Thomas L Cable—High performance fuel cell interconnect with integrated flow paths and method for making same. P.N. application 200300877498—herein referred to as 498. A similar device is used in the Voltage Dosimeter.

### FEDERALLY SPONSORED RESEARCH GRANTS

There are no Federally sponsored research grants available to those involved in the research and development of this device.

### BACKGROUND OF THIS INVENTION

Fuel cells and many devices that are voltage producing sources, such as solar cells, must constantly generate the full amount of voltage needed to operate all connected circuits. Connections between these devices will be needed as requirements expand. It is desirable to have a device available, which automatically controls circuit voltage to minimize the need for constant voltage generation in fuel cells and other voltage producing devices without compromising circuit function, and which provides automatic switching.

### BRIEF SUMMARY OF THE INVENTION

It is an object of the present invention to provide a method and apparatus to control voltage in fuel cells and other voltage producing sources to produce and deliver appropriate varying circuit voltage to decrease voltage production by placing the negative electrode of the voltage producing source in a predetermined range. It is a further object of this invention to provide automatic switching between these devices to provide extra voltage when needed.

In carrying out the above objects and other stated objects and features of the present invention a method and apparatus is provided as a Voltage Dosimeter for maintaining a desired voltage level at the negative electrode (herein named the entrance voltage) of a voltage producing source, and includes delivering a first voltage producing dose to the positive electrode (herein named the exit voltage) of the voltage producing source producing an exit voltage dose selected from one of a plurality of exit voltage doses between a first exit voltage dose and a second exit voltage dose. The method includes delivering a second voltage producing dose to the circuit while repeatedly sequencing through the plurality of sequential exit voltage doses beginning with the first exit voltage dose and proceeding to an adjacent exit voltage dose in the sequence after a predetermined time interval has elapsed. The second voltage producing dose is delivered until the entrance voltage level attains the desirable level, at which point corresponding exit voltage and voltage producing doses are selected from the plurality of sequential voltage producing and exit voltage doses. The method also includes delivering the selected exit voltage and voltage producing doses so as to maintain the desired entrance voltage level.

In the preferred embodiment the method and apparatus automatically selects an appropriate reactive gas dose to maintain a desired entrance voltage level of a fuel cell, for which the system is particularly suited, and is the preferred voltage producing source, and includes delivering a first reactive gas flow rate to the fuel cell, producing an exit voltage dose in the fuel cell selected from one of a plurality of exit voltage doses between a first exit voltage dose and a second exit voltage dose. The method includes delivering the second reactive gas flow rate to the fuel cell while repeatedly sequencing through the plurality of sequential exit voltage doses beginning with the first exit voltage dose and proceeding to an adjacent exit voltage dose in the sequence after a predetermined time interval has elapsed. The second reactive gas flow rate is delivered until the entrance voltage attains the desirable level, at which point a corresponding exit voltage dose and reactive gas flow rate are selected from the plurality of sequential exit voltage doses and reactive gas flow rates. The method also includes delivering the selected exit voltage dose and the reactive gas flow rate so as to maintain the desired entrance voltage level.

The advantages of the Voltage Dosimeter are minimal needs for constant voltage production in fuel cells and other voltage producing sources, the availability of switching voltage between these devices as the need arises, and a reduction in the cost of electricity.

The above objects, features, and other advantages will be readily appreciated by one of ordinary skill in the art from the following detailed description of the best mode for carrying out the invention, when taken in connection with the accompanying drawings.

### BRIEF DESCRIPTION OF THE DRAWINGS

FIG. 1/6 demonstrates a perspective view of the first embodiment of the present invention.

FIG. 2/6 is a graphical demonstration of the flow charts of the Voltage Dosimeter.

FIG. 3/3-5/6 are flow charts dealing with the voltage and reactive gas strategy of the present invention for use in the Voltage Dosimeter.

FIG. 6/6 is a flow chart for relating parameters in the Voltage Dosimeter.

### DETAILED DESCRIPTION OF THE INVENTION

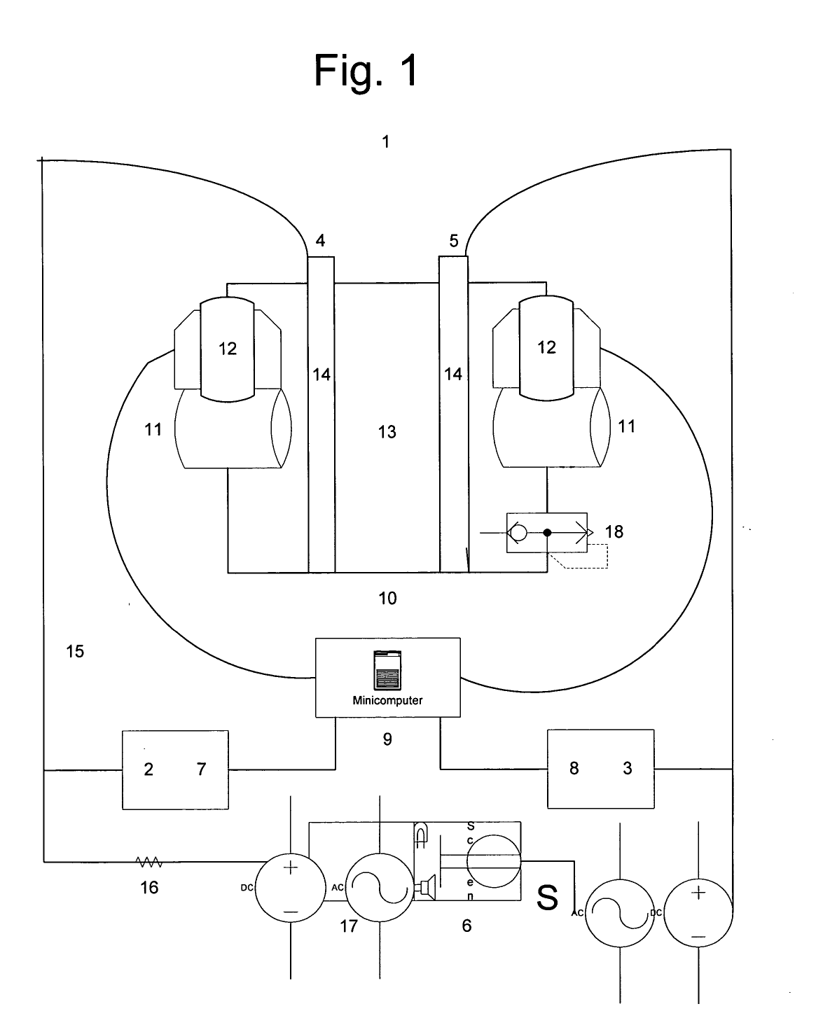

Referring now to FIG. 1/6, a first embodiment of the present invention is shown. This embodiment indicated by reference number 1 in FIG. 1/6 is the best mode in implementing this invention and is particularly suited for use as a Voltage Dosimeter. FIG. 1/6 includes two voltometers 2 and 3—one volometer 2, which measures exit voltage—v1—at the positive electrode 4 of a voltage delivery system and a second voltometer 3, which measures entrance voltage—v2—at the negative electrode 5 of a voltage delivery system. Two band pass electrical filters 7 and 8 are connected to each voltometer 2 and 3, then to an electronic control unit (ECU) 9, which exercises control strategy, and processing and analyzing voltage data to maintain v2 in a specific range. The ECU 9 preferably operates on power delivered from either D.C. or A.C. power supplies allowing portability to the Voltage Dosimeter System.

With continuing reference to FIG. 1/6 a fuel cell 10 as described in U.S. patent application Ser. No. 498 is added as the preferred embodiment of a voltage delivery system. The two reactive gas flow rates at the inlets 11 are controlled by two ECU 9 controlled variably opening solenoid valves 12 with Coulomb controlling circuits, as was taught in 877 and U.S. Pat. No. 5,008,773. Reactive gases pass through an electrolyte solution 13, then react at the electrodes 14. A typical reaction is 2H2+O2=2H2O+4e−+heat, thus producing voltage in an electric wire 15 with resistance 16. A circuit 6, such as that of a family dwelling, is pictured. Adequate voltage delivery here is the object of the present embodiment. A battery 17 is supplied for use when extra power is needed. Optional DC/AC converters 17 and AC//DC converters 6 are included for better use of conventional appliances.

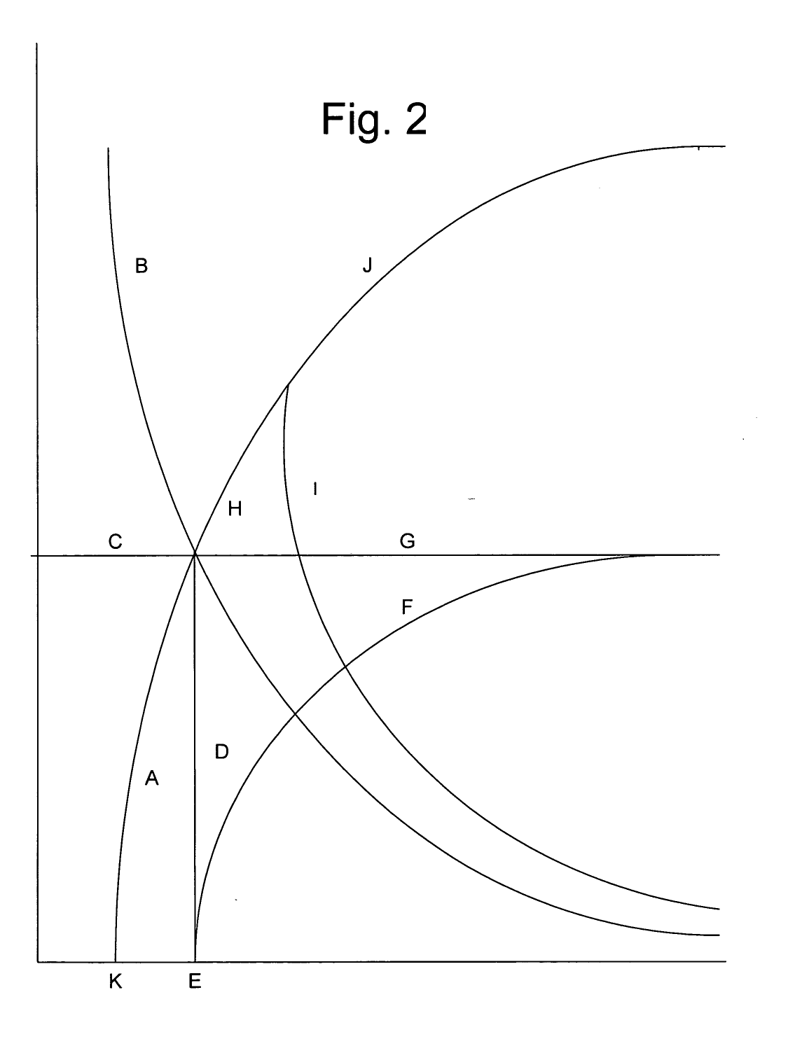

Referring now to FIG. 2/6, the method of device function is demonstrated graphically. Voltage is placed on the ordinate and time, reactive gas flow rate, and voltage producing dosage are placed on the abscissa of a Cartesian plane. Maximum reactive gas flow rate or voltage producing dosage occurs at tr on the abscissa, the significance of which will be presented later. Measured and calculated logarithmic functions are used in the preferred embodiment as exit voltage doses, but any measured and estimated transcendental function with an inverse may be used.

Referring again to FIG. 1/6, as will be seen, conditions on v2—the entrance voltage—control reactive gas flow rate 11 and thus v1—exit voltage, circuit voltage, circuit voltage dosage, and finally entrance voltage—v2—itself.

Referring now to FIG. 2/6, the illustrated method of reactive gas flow rate and exit voltage dosage selection starts with the administration of an extreme reactive gas flow rate—herein referred to as the selector dose of the reactive gas flow rate which produces the maximum or minimum voltage producing and exit voltage dose at the positive electrode of the fuel cell or of any voltage producing device—as in curve A or B. Curve A is represented by y=log to the base a of x. Curve A activates at x=0.

Line CG is the desired voltage of v2—herein referred to as the selection parameter, which is a range in the actual device. At the intersection of line CG and curve A or B (call it X), line D points to point E on the abscissa as the selected reactive gas flow rate or voltage producing dose. This is determined by graphical means and, as will be seen, the flow charts. The virtual exit voltage dose logarithm is curve F, which activates at point E, the selected voltage producing dose, and is boosted by curves A, B, H—an overshoot of curve A—and curve I—a deactivation of curve H—to produce line G, which is the selected exit voltage dose and here is an exit voltage as well, because it is a horizontal line, and is represented by y=log to the base b of tr, where tr is the t value of the flattening out of the logarithm y=log to the base b of t (curve F) at tr seconds. Line G is completely determined by the intersection (X) described above and in the flow charts, as will be seen, thus the determination of lines F and G by the above methods is unnecessary. Curve F and G start in the x coordinate system at x=t and in the t coordinate system at t=0, when curve A deactivates. Curve F and G deactivate when curve A activates. Curve J is the virtual curve of curves A and H. K marks the Circulation time. It marks the time from the initial reactive gas flow rate to the first recording of v1. Its accuracy is essential for proper flow chart function with respect to time. Its calculation and that of tr will be demonstrated. The voltage producing dose is circulation time dependent. The exit voltage dose is not, since it is a function of time. At line CG v1 usually differs from v2 in value. At the above mentioned intersection (X) v2 is in its desired range and v1 is selected as the selected exit voltage dosage, which determines the selected voltage producing dosage. Until the above intersection (X) the line CG can not be placed on the Cartesian plane.

Before describing the flow charts it is useful to explain the terminology employed. The most recent base state keeps v2 (the entrance voltage) in its desirable range. V1 (the exit voltage) and v2 are measured in all states. The washout state washes out overshoots. It also determines the voltage producing dose or in the fuel cell the reactive gas flow rate, as will be seen. For the fuel cell Voltage Dosimeter exit voltage doses are functions of reactive gas flow rates. For other voltage producing devices, exit voltage doses are functions of other voltage producing dosage mechanisms—motion, magnetism, heat or technologies producing heat.

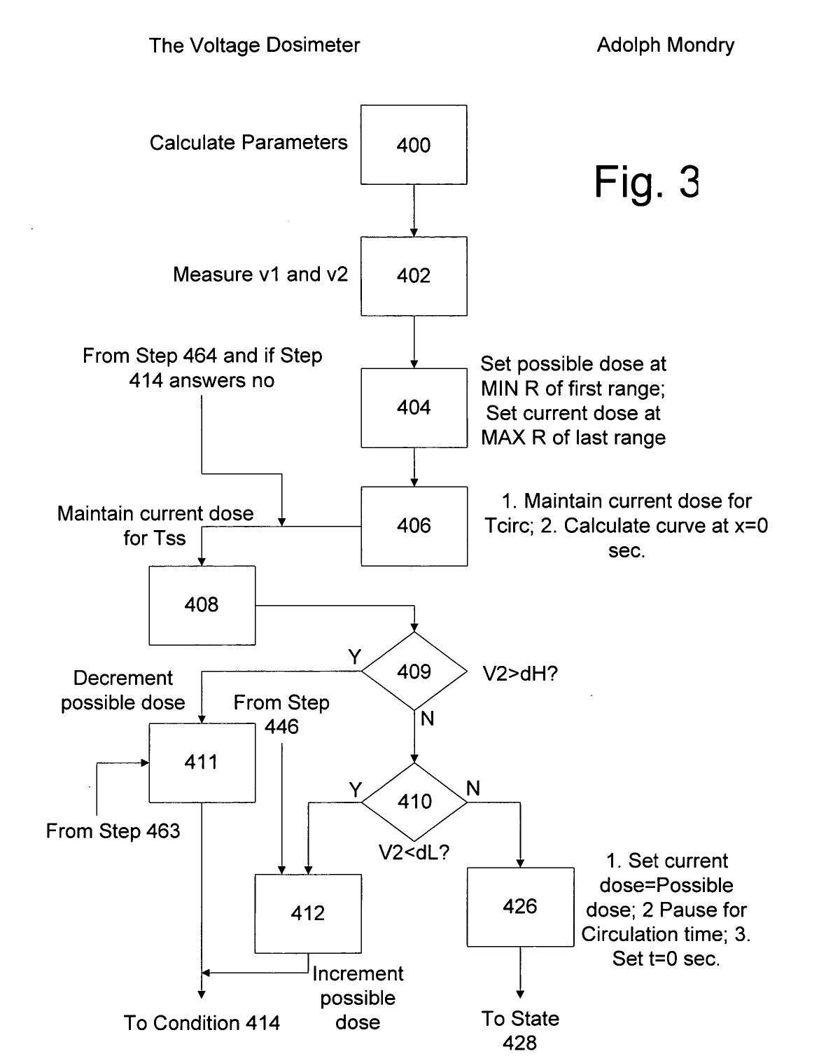

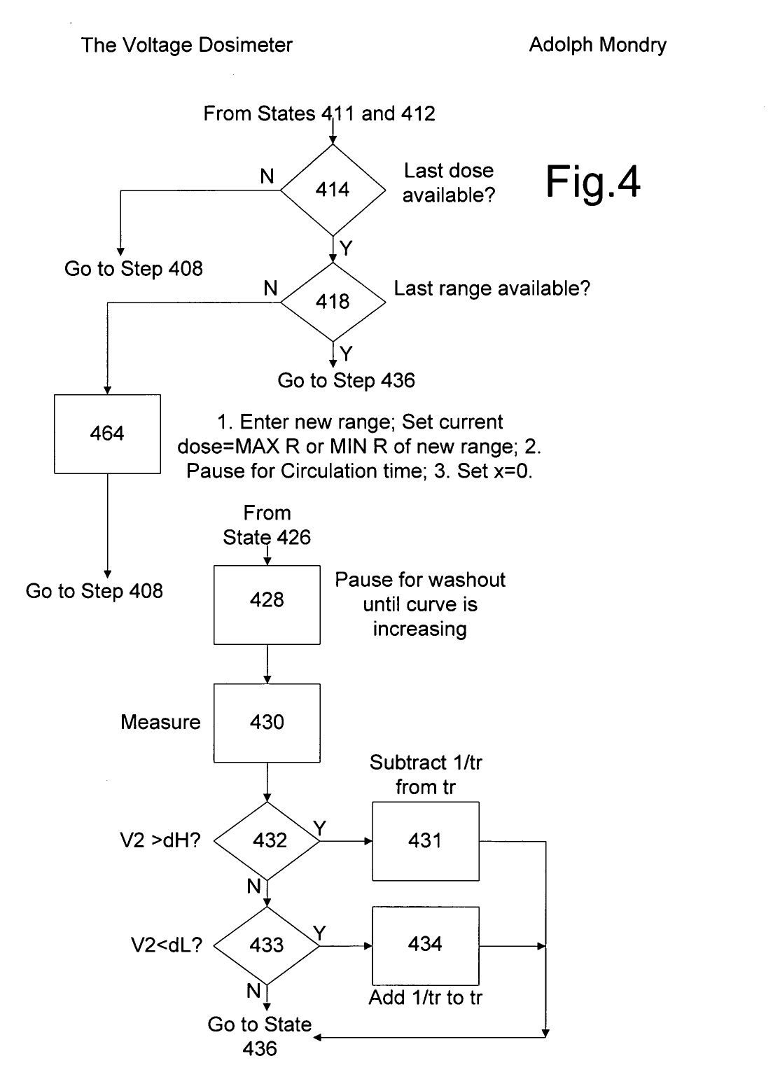

Referring now to FIG. 3/6-5/6, flow charts are shown, which illustrate the system and method for the proper selection of exit voltage doses, voltage producing doses, and reactive gas flow rates.

Referring to FIG. 3/6, Step 400 determines various system parameters, which may be predetermined and stored in memory, calculated by an ECU (such as ECU 9 in FIG. 1/6) or entered by a system operator. The system parameters include the following:
MIN R=minimum dose of voltage production and exit voltage given for each range.
MAX R=maximum dose of voltage production and exit voltage given for each range.
V1=exit voltage.
V2=entrance voltage. When it equals zero for ten seconds, the device deactivates and reactivates when the battery discharges in response to the closing of a circuit switch.
Tv1=desired exit voltage.
dL=low v2 threshold.
dH=high v2 threshold.
TSS=series state delay time.
Tcirc=circulation delay time.
Twash=washout delay time.
TR=desired response time or reaction time
   To calculate dH and dL close all circuits. Increase v1 until all circuits first function properly. Measure v2. This is dL. Do the same with the smallest circuit. This is dH.

As shown in FIG. 3/6 the ECU now passes control to Step 402, which measures v1 and v2. At Step 404 a maximum exit voltage and voltage producing dose of the last range is administered. This is represented graphically by curve A of FIG. 2/6 and is called the selector dose. It represents the maximum exit voltage dose. The possible exit voltage dose is set for the lowest dose of the lowest range.

With continuing reference to FIG. 3/6 at Step 406 v1 is maintained while pausing Tcirc seconds, then x is set to 0 seconds. Step 406 is called an adjustment state. It coordinates the flow charts with respect to time. Initial circulation times may be estimated or measured.

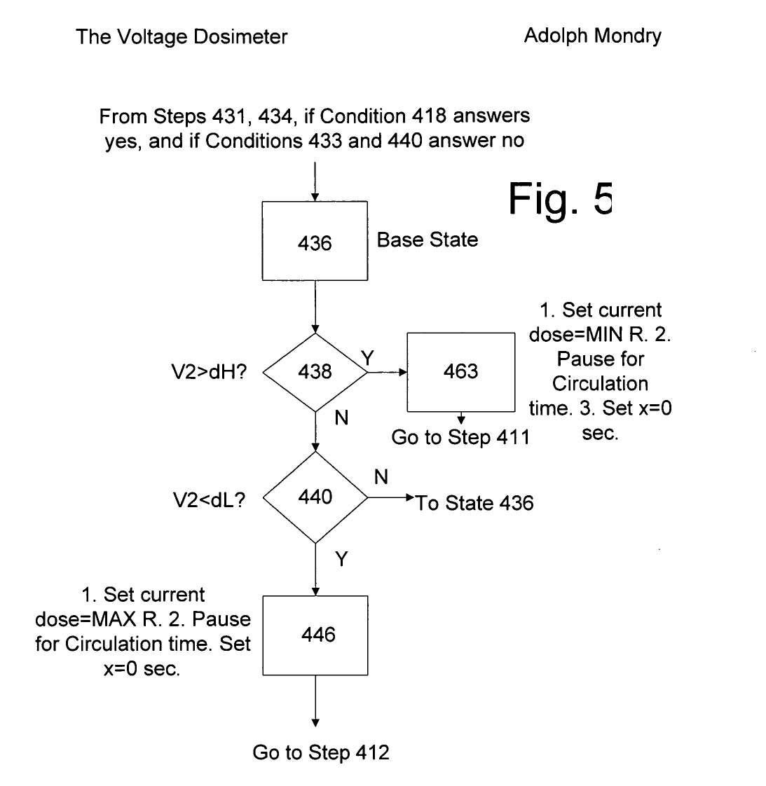

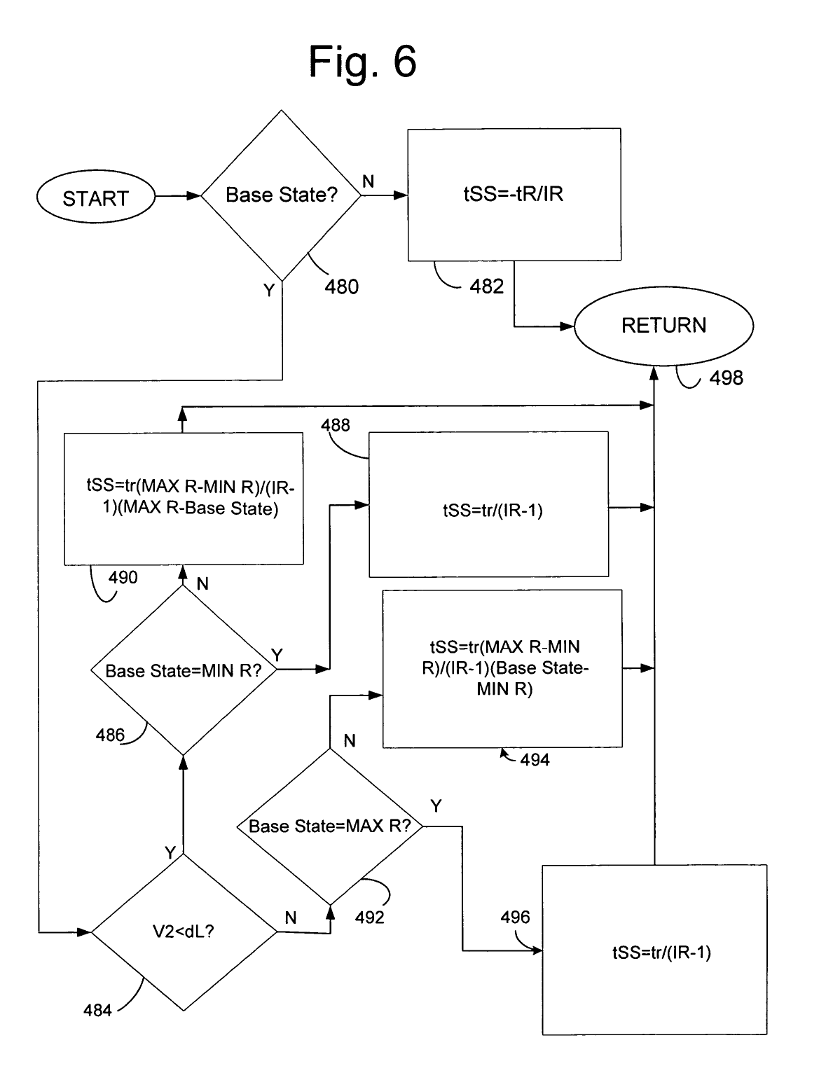

Referring once again to FIG. 3/6 the ECU passes control to Step 408, which continues to deliver exit voltage to v1. Step 408 is referred to as a series state—Tss—and is necessary to coordinate the progression through various possible doses within a time period determined by tr. The calculation of Tss depends on the current operating state. Some representative calculations are illustrated in FIG. 6/6 for a single ranged implementation as discussed in greater detail below.

Still referring to FIG. 3/6 a test is performed at Steps 409 and 410. It asks—is v2 greater than dH?—and, is v2 less than dL?, respectively. They split control into three pathways. Negative answers to both conditions direct control to Step 426, where 1. The definitive current exit voltage dose is set to the possible dose, while the preliminary voltage producing dose is set one circulation time into the future. 2. A pause for the circulation time takes place. Then, 3. t is set to 0. This represents preliminary voltage producing dose and definitive exit voltage dose selection.

Now referring to FIG. 4/6 processing continues with the ECU directing control to Step 428, which pauses to washout high valued functions from the selected dose. The state is completed when all involved functions equal a straight line—the selected exit voltage dose. For convenience in the representation of the method in the flow charts the ECU was represented to set t=0 in Step 426. This actually occurs at the start of the washout state. The ECU directs in the washout state the determination of the selected value of point E of FIG. 1/6—the definitive selected voltage producing dose or the selected reactive gas flow rate in the case of the fuel cell Voltage Dosimeter—then activates these doses. The exit voltage dose remains the selected dose as curve G in FIG. 1/6. Both of the above dosages continue until activation of MIN R or MAX R. FIG. 430 measures voltage values for the Conditions below. Steps 409 and 410 represent a second test and ask the same questions as the above mentioned first test—Is v2 greater than dH or less than dL, respectively? If either answer yes, control is directed to Steps 431 and 434, respectively, where a predetermined fraction of tr is either subtracted or added, respectively to tr. This pathway determines tr only if the circulation time is correct. The circulation time is calculated by keeping the last three base state values in memory. When control is directed to or beyond a noncontiguous base state from which control was originally assumed a predetermined amount of time is added to the circulation time. This will correct abnormally short circulation times. For abnormally long circulation times—if control passes consecutively to two ascending or descending base states, a predetermined amount of time is subtracted from the circulation time.

Referring now to FIG. 5/6, if both conditions in the second test answer no, the ECU places control in Step 436, the base state. Steps 438 and 440 represent the third test and ask the same questions (is v2>dH or <dL?) as those of the previous tests with different consequences. They determine the stability of the base state (both conditions answer no if it is stable). If it is unstable, the ECU directs control to either Step 463, if Step 438 answers yes, or 446, which 1. Minimizes or maximizes the current dose, respectively 2. Pauses for the circulation time, then 3. sets x=0. These doses continue until dose selection. It should be noted that Steps 431, 434, the yes part of 418, and the no part of Steps 433 and 440 all yield control to Step 436, the base state. The ECU then directs control from Step 463 to Step 411, and from Step 446 to Step 412.

Referring again to FIG. 3/6, the ECU directs control from Step 464 (evaluated later), and if Step 414 in FIG. 4/6 (the first condition of fourth test to be elucidated soon) answers no, to Step 408 to maintain the current exit voltage dose for Tss. Control is then directed to Step 409, which, if along with Step 410—the first test—the answer is yes to both conditions, control is passed to Steps 411 and 412, respectively, which decrement and increment the possible dose, respectively, then both pass control to Condition 414.

Referring now to FIG. 4/6, Steps 414 and 418 represent the fourth and final test with different conditions than the other tests. These conditions ask if the present possible dose is the last dose available, and if the present range is the last one available, respectively. If Step 414 answers no, control is directed by the ECU to Step 408 in FIG. 3/6, which maintains a current dose for Tss. If the condition answers yes, control is directed to Step 418, which determines if the present range is the last range available. If it answers no, control is directed to Step 464, in which control enters a new range, sets the current exit voltage and voltage producing dose to MAX R or MIN R of the new range, pauses for the circulation time, then sets x=0. Control is then directed to Step 408, which maintains a current exit voltage dose for Tss. If Step 418 answers yes, the ECU directs control to Step 436, the base state.

Referring now to FIG. 6/6 a flow chart is shown illustrating representative calculations of Tss according to the present invention. One of these calculations or an analogous calculation is performed for each series state of FIG. 3/6-5/6, such as illustrated at Steps 408, 411, and 412.

Returning to FIG. 6/6 at Step 480 a test is performed to determine if the system has reached a base state. If not, the series state delay is estimated as: Tss=tr/IR. If the result is true, the process continues with Step 484, where a test is performed to determine whether v2<dL. If true, then Step 486 determines whether the most recent base state is a minimum for the current range. If it is true, the series state delay is calculated by Step 488 as Tss=tr/(IR−1). Step 498 then returns control to the series state which initiated the calculation.

With continuing reference to FIG. 6/6, if the test at Step 486 is true, then the series state delay is calculated by Step 490 as Tss=tr(MAX R−MIN R)/(IR−1)(MAX R−BASE STATE) before control is released to the series state via Step 498. If the test performed at Step 484 is false, then Step 492 performs a test to determine if the most recent base state is the maximum for the current range. If the result of Step 492 is true, then Step 496 calculates the series state delay as Tss=tr/(IR−1). Control is then returned to the appropriate series state via Step 498. If the result of the test at Step 492 is false, then the series state delay is calculated by Step 494 as Tss=tr(MAX R−MIN R)/(IR−1)(BASE STATE−MIN R). Step 498 then returns control to the appropriate series state. FIG. 6/6 applies to a single range. One of ordinary skill in the art should appreciate that the calculations may be modified to accommodate a number of possible ranges.

It should be apparent by any one skilled in the art that the flow charts provide a method and apparatus for a Voltage Dosimeter.

Other Voltage Dosimeters use other means to produce voltage. Fission reactors, mechanical/magnetic reactors, fusion reactors, solar cells, steam/turbine reactors, and fossil fuel burning reactors can function as Voltage Dosimeters controlling voltage in corresponding circuits by the same method and with same apparatus as the fuel cell Voltage Dosimeter. The range used for v2 depends on the application. Switching function between voltage producing devices employs Step 418 of FIG. 4/6—last range available?—If it answers yes, control passes to Step 436, the base state, where voltage passes from the device. For all other steps, voltage is transfered to the device.

1. A method for maintaining desired negative electrode voltage of a voltage producing source within a first predetermined range of values having an upper limit and a lower limit so as to control the positive electrode voltage of the voltage producing source and connected circuits to eliminate the necessity for constant maximum voltage production, the method being adapted for use with a Voltage Dosimeter including an electronic control unit (ECU) having memory, two voltometers connected to each electrode for measuring current voltage at each electrode, a voltage producing source controlled by the ECU for delivering selected voltage producing doses and positive electrode voltage doses to the circuit, the voltage producing source having a plurality of voltage producing doses and positive electrode voltage doses ranging from a first dose to a second dose, the method comprising:
delivering the second voltage producing dose and positive electrode voltage dose to the circuit while repeatedly sequencing through the plurality of sequential positive electrode voltage doses beginning with the first dose and proceeding to an adjacent dose in the sequence after a predetermined time interval has elapsed until the current negative electrode voltage level of the voltage producing source attains the desired voltage level at which point a corresponding positive electrode voltage dose and voltage producing dose are selected from the plurality of sequential voltage producing and positive electrode voltage doses;
delivering the selected positive electrode voltage and voltage producing doses so as to maintain the negative electrode voltage level in its desired range.

2. The method of claim 1 wherein the current circulation time is determined by:
means for storing a predetermined number of base state exit voltage values in memory; and
means for determining a predetermined sequence of base state levels.

3. The method of claim 1 wherein the reaction time is determined by logic flow charts.

4. The method of claim 1 in which a plurality of sequential positive electrode voltage doses are generated in fuel cells, steam reactors, fission reactors, fusion reactors, solar cells, mechanical/magnetic voltage generators, and fossil fuel burning reactors.

5. The method of claim 1 wherein a plurality of sequential positive electrode voltage doses are generated by steam.

6. The method of claim 1 wherein the plurality of positive electrode voltage doses are connected by logical switches.

7. The method of claim 1 wherein a predetermined negative electrode voltage level for a predetermined amount of time produces a predetermined voltage producing and positive electrode voltage dose.

8. The method of claim 1 wherein a first closing of an electric switch produces a first battery discharge and a first negative electrode voltage level in a fuel cell.

9. The method of claim 1 wherein the operating negative electrode voltage range varies with application.

10. The method of claim 1 wherein a first closing of an electric switch produces a first battery discharge and negative electrode voltage.

11. A method for maintaining a desired negative electrode voltage of a fuel cell within a first predetermined range of values having an upper limit and a lower limit so as to control the positive electrode voltage of the fuel cell and connected circuits to eliminate the necessity for constant maximal voltage production, the method being adapted for use with a Voltage Dosimeter including an electronic control unit (ECU) having memory, two voltometers connected to each electrode for measuring current voltage at each electrode, a fuel cell controlled by the ECU for delivering selected reactive gas flow rates to the fuel cell and positive electrode voltage doses to the fuel cell and connected circuits, the fuel cell as a voltage producing source having a plurality of reactive gas flow rates and positive electrode voltage doses ranging from a first dose to a second dose, the method comprising:
delivering the second reactive gas flow rate and the positive electrode voltage dose to the fuel cell and connected circuits while repeatedly sequencing through the plurality of sequential positive electrode voltage doses beginning with the first dose and proceeding to an adjacent dose in the sequence after a predetermined time interval has elapsed until the current negative electrode voltage level of the fuel cell attains the desired voltage level at which point a corresponding positive electrode voltage dose and a reactive gas flow rate are selected from a plurality of positive electrode voltage doses and reactive gas flow rates.
delivering the selected reactive gas flow rate and the positive electrode voltage dose to the fuel cell so as to maintain the negative electrode voltage in the desired range.

12. The method of claim 11 wherein the current circulation time is determined by:
means for storing a predetermined number of base states;
means for storing positive electrode voltage dose values in memory;
means for determining a predetermined sequence of base states;
means for determining a predetermined sequence of positive electrode voltage doses.

13. The method of claim 11 wherein the reaction time is determined by logic flow charts.

14. The method of claim 11 wherein a predetermined negative electrode voltage level for a predetermined amount of time produces a predetermined reactive gas flow rate and positive electrode voltage dose.

15. The method of claim 11 wherein a first closing of an electric switch produces a first battery discharge and a negative electrode voltage level.

16. The method of claim 11 wherein the operating negative electrode voltage level is determined by direct observation.

17. The method of claim 11 wherein the plurality of positive electrode voltage doses are connected by switches controlled by logic.

18. A system for maintaining a desired negative electrode voltage level of a voltage producing source within a first predetermined range of values having an upper limit and a lower limit so as to control the positive electrode voltage of the voltage producing source and connected circuits to eliminate the necessity for constant maximum voltage production, the method being adapted for use with a Voltage Dosimeter including an electronic control unit (ECU) having memory, two voltometers connected to each electrode for measuring current voltage at each electrode, a voltage delivery apparatus controlled by the ECU for delivering a selected voltage producing dose to the positive electrode and to the circuits, the voltage delivery apparatus having a plurality of sequential voltage producing doses ranging from a first voltage producing dose to a second voltage producing dose, the method comprising:
delivering the second voltage producing dose to the positive electrode and to the circuits while repeatedly sequencing through the plurality of sequential voltage producing doses beginning with the first voltage producing dose and proceeding to an adjacent voltage producing dose in the sequence after a predetermined time interval has elapsed until the current negative electrode voltage level of the voltage delivery apparatus attains the desired voltage level at which point a corresponding voltage producing dose is selected from the plurality of sequential voltage producing doses;
delivering the selected voltage producing dose so as to maintain the negative electrode voltage level in its desired range.

19. The method of claim 18 wherein the current circulation time is determined by:
means for storing a predetermined number of base state exit voltage values in memory; and
means for determining a predetermined sequence of base state levels.

20. The method of claim 18 wherein the reaction time is determined by logic flow charts.

21. The method of claim 18 in which a plurality of sequential positive electrode voltage doses are generated in fuel cells, steam reactors, fission reactors, fusion reactors, solar cells, mechanical/magnetic voltage generators, and fossil fuel burning reactors.

22. The method of claim 18 wherein a plurality of sequential positive electrode voltage doses are generated by steam.

23. The method of claim 18 wherein the plurality of positive electrode voltage doses are connected by logical switches.

24. The method of claim 18 wherein a predetermined negative electrode voltage level for a predetermined amount of time produces a predetermined voltage producing and positive electrode voltage dose.

25. The method of claim 18 wherein a first closing of an electric switch produces a first battery discharge and a first negative electrode voltage level in a fuel cell.

26. The method of claim 18 wherein the operating negative electrode voltage range varies with application.

27. The method of claim 18 wherein a first closing of an electric switch produces a first battery discharge and negative electrode voltage.

28. A method for maintaining a desired negative electrode voltage of a fuel cell within a first predetermined range of values having an upper limit and a lower limit so as to control the positive electrode voltage of the fuel cell and connected circuits to eliminate the necessity for constant maximal voltage production, the method being adapted for use with a Voltage Dosimeter including an electronic control unit (ECU) having memory, two voltometers connected to each electrode for measuring current voltage at each electrode, a fuel cell controlled by the ECU for delivering selected reactive gas flow rates to the fuel cell, the fuel cell having a plurality of sequential reactive gas flow rates ranging from a first reactive gas flow rate to a second reactive gas flow rate, the method comprising:
delivering the second reactive gas flow rate to the fuel cell while repeatedly sequencing through the plurality of sequential reactive gas flow rates beginning with the first reactive gas flow rate and proceeding to an adjacent reactive gas flow rate in the sequence after a predetermined time interval has elapsed until the current
negative electrode voltage level of the fuel cell attains the desired voltage level at which point a corresponding reactive gas flow rate is selected from a plurality of reactive gas flow rates.
delivering the selected reactive gas flow rate to the fuel cell so as to maintain the negative electrode voltage in the desired range.

29. The method of claim 28 wherein the current circulation time is determined by:
means for storing a predetermined number of base states;
means for storing positive electrode voltage dose values in memory;
means for determining a predetermined sequence of base states;
means for determining a predetermined sequence of positive electrode voltage doses.

30. The method of claim 28 wherein the reaction time is determined by logic flow charts.

31. The method of claim 28 wherein a predetermined negative electrode voltage level for a predetermined amount of time produces a predetermined reactive gas flow rate and positive electrode voltage dose.

32. The method of claim 28 wherein a first closing of an electric switch produces a first battery discharge and a negative electrode voltage level.

33. The method of claim 28 wherein the operating negative electrode voltage level is determined by direct observation.

34. The method of claim 28 wherein the plurality of positive electrode voltage doses are connected by switches controlled by logic.
